(19) United States
(12) Patent Application Publication
(10) Pub. No.: US 2026/0269451 A1
(43) Pub. Date: Sep. 10, 2026

(54) CONTROL ARM BRACKET ASSEMBLY

(71) Applicant: AmpThink, LLC, Garland, TX (US)

(72) Inventors: Dion Joe CASTO, Nevada, TX (US); William C. ANDERSON, III, Dallas, TX (US)

(21) Appl. No.: 19/559,794

(22) Filed: Mar. 6, 2026

Related U.S. Application Data
(60) Provisional application No. 63/768,345, filed on Mar. 7, 2025.

(51) Int. Cl. H01Q 1/12; H01Q 3/08

(52) U.S. Cl. CPC H01Q 1/1228; H01Q 1/125; H01Q 3/08

(57) ABSTRACT

A control arm mounting bracket assembly is disclosed that provides a convenient way to mount an electronic device above a large open space, such as a stadium. A mounting bracket is attached to a control arm that is attached to a structural member in a building so that an electronic device mounted to the mounting bracket hangs up to several feet below the structural member. An electronic device, such as a WiFi antenna, can be attached to the mounting bracket assembly and the radiation pattern from the WiFi antenna can be adjusted as necessary by adjusting the mounting bracket assembly. A controller allows a user to control an azimuth and tilt for the antenna from several feet away, directly or via remote control, from the location of the antenna. This provides a safe and effective way to perform this function and eliminates a need for expensive and dangerous lift equipment.

### BACKGROUND

Large public spaces with open areas and high ceilings, such as stadiums, arenas, theatres, etc. pose unique problems providing electronic coverage (i.e., WiFi, lighting, etc.) to a floor and seating area disposed therein. Due to many obstacles that are attached to an arena ceiling such as lights, scoreboards, catwalks, beams, etc., blocking radiation (WiFi signal, light, etc.) from electronic devices, there is a problem locating electronic devices where they can have an unobstructed radiation pattern to obtain maximum coverage to the space.

### SUMMARY

A control arm mounting bracket assembly is disclosed herein that provides a convenient way to mount an electronic device, such as a network antenna, above a large open space. A mounting bracket is attached to a control arm that may be attached to a ceiling structure to hang several feet below ceiling obstacles. An electronic device, such as a WiFi antenna, can be attached to the mounting bracket assembly and the radiation pattern from the WiFi antenna can be adjusted as necessary by adjusting the mounting bracket assembly. A controller that is releasably connected to the mounting bracket assembly allows a user to control an azimuth and tilt for the antenna from several feet away from the location of the antenna. This provides a safe and effective way to perform this function and eliminates a need for expensive and dangerous lift equipment.

### BRIEF DESCRIPTION OF THE DRAWINGS

A particular description of the principles briefly described above will be rendered by reference to specific embodiments thereof, which are illustrated in the appended drawings. Understanding that these drawings depict only certain exemplary embodiments of the disclosure and are not therefore to be considered to limit its scope, the principles herein are described and explained with additional specificity and detail through the use of the accompanying drawings.

FIG. 1 is a depiction of an example control arm bracket assembly and a closeup view of a controller assembly used therein.

FIG. 2 is a depiction of the controller assembly as used in the example control arm bracket assembly shown in FIG. 1 and in accordance with the present description.

FIG. 3 is a depiction of an example control arm bracket assembly releasably attached to a structural support member and having a wireless antenna enclosure attached thereto.

FIG. 4 is an enlarged depiction of a portion of the example control arm assembly shown in FIG. 3.

### DETAILED DESCRIPTION

The apparatuses and techniques describe herein relate to a control arm mounting bracket assembly. In particular, an improved control arm bracket assembly allows electronic devices (WiFi antennas, lights, etc.) to hang from ceiling fixtures to get a proper radiation coverage area. Although control arm bracket assemblies may be used in a variety of applications and environments, the present discussion will focus on use of the described control arm bracket assemblies in a wireless network that includes electronic components housed in enclosures that are connected by electronic cables and/or wireless signals.

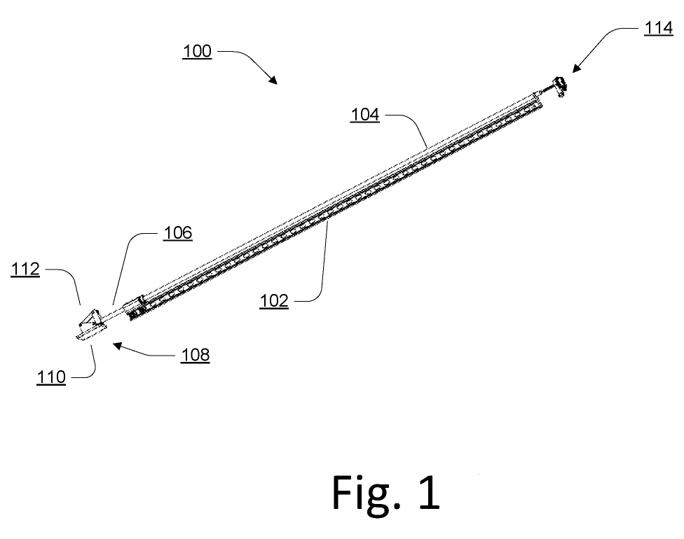

FIG. 1 is a depiction of an example control arm bracket assembly 100 (hereinafter referred to as a control arm bracket 100). The example control arm bracket 100 includes a support bar 102 that has a distal end and a proximal end. A control rod sleeve 104 is mounted to the support bar 102 and has a distal end and a proximal end that are relatively positioned near the distal end and the proximal end, respectively, of the support bar 102. A control rod 106 is disposed inside the control rod sleeve 104 and is freely rotatable therein. The control rod 106 has a distal end and a proximal end that are relatively positioned near the distal end and the proximal end, respectively, of the support bar 102.

A mounting plate assembly 108 includes a mounting plate 110 and a tilt mechanism 112. The mounting plate 110 is configured to mount an electrical device or enclosure, such as a WiFi antenna or its enclosure to the mounting plate 110. In the present example, the mounting plate assembly 108 is attached to the distal end of the control rod 106. In the presently described embodiment, the tilt mechanism 112 is connected to the control rod 106 and to the control rod sleeve 104. When the control rod sleeve 104 is rotated, an azimuth of the mounting plate assembly 108 is changed, thus changing an azimuth of an electronic device (not shown) mounted on the mounting plate 110. When the control rod 106 is rotated, the tilt mechanism 112 is actuated to change a tilt of an electronic device (not shown) mounted on the mounting plate 110.

The example control arm bracket assembly 100 can be mounted to a ceiling or other structure by way of a mounting bracket (not shown) connected to the proximal end of the support bar 102. Any device of method known in the art for connecting a vertical bar to a structural piece of a building may be used for this purpose.

Generally, the present invention can be implemented with the following element: a device mount, an azimuth control mechanism, a tilt control mechanism, a mounting bracket to secure the example control arm bracket assembly 100 to a building structure, and an extension member to provide a distance between the mounting bracket and the device mount.

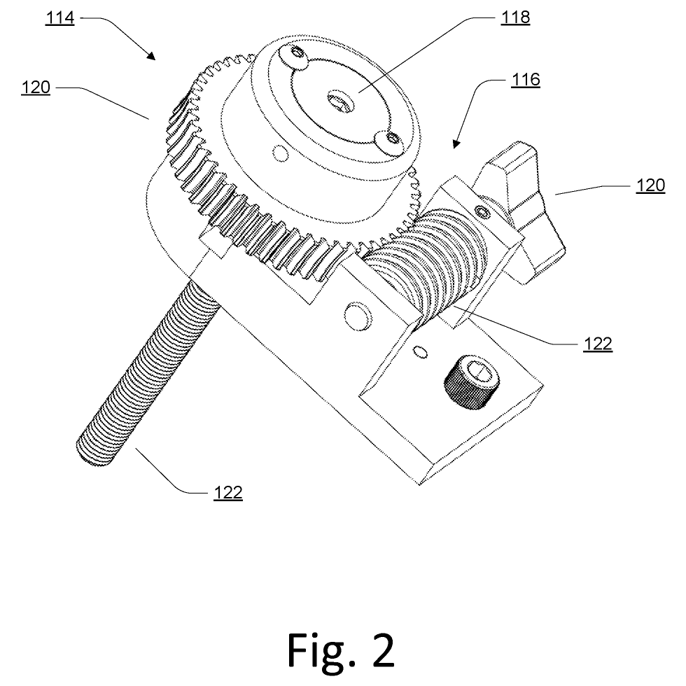

FIG. 2 is an enlarged depiction of the controller assembly 114 as used in the example control arm bracket assembly 100 shown in FIG. 1 and in accordance with the present description. The controller assembly 114 includes a tilt control 116 and an azimuth control 118. The tilt control 116 in the present example includes an adjustment knob 120 and a screw thread 122. The screw thread 122 is configured to engage with gear teeth 124 attached directly or indirectly to the control rod 106. Turning the adjustment knob 120 engages the screw thread 122 and gear teeth 124 and causes the control rod 106 to move in or out of the control rod sleeve 104, thus changing the tilt of the tilt mechanism 112. Other means may be used to control the tilt without departing from the scope of the invention. The means shown in the present example is just one example of a functional design to control the tilt of a mounted device. Those skilled in the art will recognize other designs that can accomplish the same function.

The azimuth control 118 provides a mechanism to rotate the tilt mechanism 112 and change the azimuth of the mounting plate 110 and, thus, any device attached thereto. As shown in the present example, the azimuth control 118 is actuated by way of a hex nut 119 included in the azimuth control 118. When the hex nut 119 is rotated, the control rod 106 is rotated accordingly. This changes the azimuth of the mounting plate assembly 108, which redirects radiation from an electronic device attached to the mounting plate 110. Other means may be used to control the azimuth without departing from the scope of the invention. The means shown in the present example is just one example of a functional design for controlling the azimuth of a mounted device. Those skilled in the art will recognize other designs that can accomplish the same function.

In one or more embodiments of the present invention, the controller assembly 114 is releasably attached to the rest of the control arm bracket assembly 100. When not in use, the controller assembly 114 may be removed and stored in a safe location, thus preventing unauthorized of unintentional movement of the tilt and azimuth of an attached electronic device.

In at least one embodiment of the present invention, the tilt control 116 and the azimuth control 118 are controlled by remote control servos that can be changed from a remote controller device (not shown). This allows a network technician to adjust the tilt an azimuth of an electronic device (e.g. a wireless network antenna) without having to access the structural connection point of the control arm bracket to a building structure. For example, if such an embodiment were implemented in a basketball arena, a technician could test coverage in any area while located in the area. Thus, adjusting network antennas would be much easier and safer.

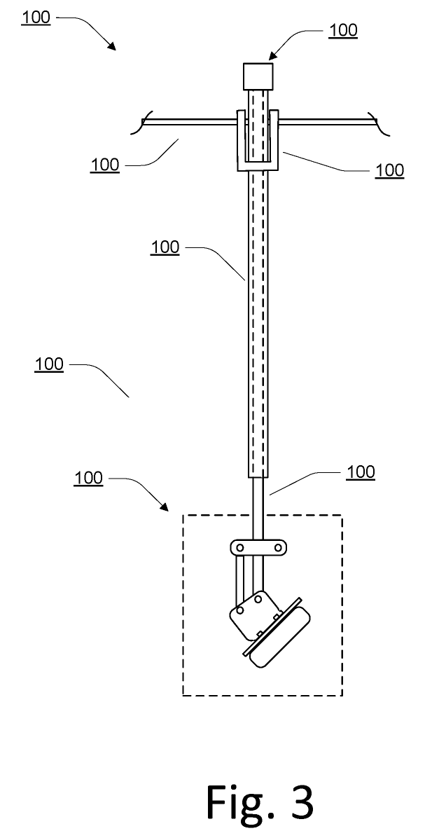

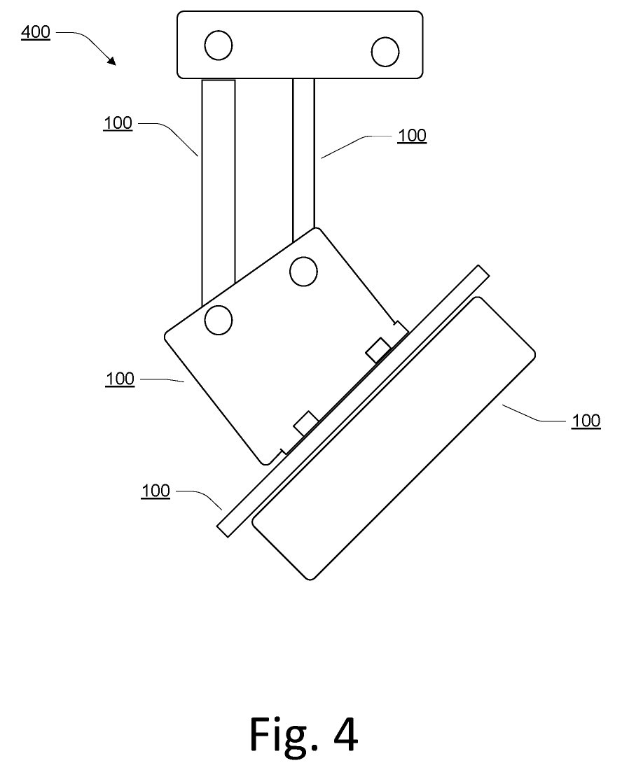

FIG. 3 is a depiction of an example control arm bracket assembly 300 having a proximal end that is releasably attached to a structural support member 302 of a building. The example control arm bracket assembly 300 also includes a wireless antenna enclosure (see FIG. 4) attached thereto. The example control arm bracket assembly 300 includes a controller assembly 304 attached to a control rod 306 and a control rod sleeve 308. A tilt mechanism 310 is attached to a distal end of the control rod 306. The example control arm bracket assembly 300 further includes attachment means 312 to attach the example control arm bracket assembly 300 to the structural member 302. Any attachment means suitable for this purpose may be used without departing from the scope of the present description. The attachment means 312 attached the example control arm bracket assembly 300 with at least one connection. In the present example, the attachment means 312 connects to the control rod sleeve 308. However, the attachment means 312 may connect in one or more other locations on the example control arm bracket assembly 300. As shown in the present example, the attachment means 312 connects to the structural member 302 in at least two locations. However, other attachment means may be used to attached the example control arm bracket assembly 300 to the structural member 302 may attached to only one or more than two locations without departing from the scope of the described invention.

The tilt mechanism 310 shown in FIG. 3 is isolated and shown in greater detail in FIG. 4.

FIG. 4 is an enlarged depiction of the tilt mechanism 310 shown in FIG. 3. In the following discussion related to FIG. 4, similar reference labels and numerals will be used in continuation from FIG. 3 where available. The tilt mechanism 310 shown in FIG. 4, depicts the control rod 306 attached to a mounting plate 400 by way of a mounting bracket 402. The mounting plate 400 provides a flat surface to which an electronic device (or its enclosure) 404 can be mounted. The mounting bracket 402 is attached to the control rod 306 by way of a control rod fastener 406 so that the control rod fastener 406 can pivot as the control rod 306 moves in and out of the control rod sleeve (308, FIG. 3), or up and down in the disposition presently shown. The mounting bracket 402 is also attached to the control arm bracket (100, FIG. 1) by way of a support bar 408. A distal end of the support bar 408 is attached to the mounting bracket 402, and a proximal end of the support bar 408 is attached to a first end of a supporting clamp 410. A second end of the supporting claim 410 is attached to the control rod 306 such that the supporting clamp 410 rotates when the control rod 306 rotates. The support bar 408 may be fixed, provided the mounting bracket 402 may freely pivot about its connection to the distal end of the support bar 408.

### CONCLUSION

While the control arm bracket assemblies are described with respect to certain embodiments and/or generally associated methods, alterations and permutations of these embodiments and application to any application, a person having ordinary skill in the art will recognize other applications in which the presently described technology may be used. Accordingly, the above description of example embodiments does not define or constrain this disclosure. Other changes, substitutions, and alterations are also possible without departing from the spirit and scope of this disclosure, as defined by the following claims.

1. A control arm mounting bracket assembly, comprising:
a support bar having a proximal end and a distal end;
a control rod sleeve mounted to the support bar, the control rod sleeve having a proximal end and a distal end corresponding to the proximal end and the distal end of the support bar;
a control rod disposed within the control rod sleeve and having a proximal end and a distal end corresponding to the proximal end and the distal end of the control rod sleeve;
a mounting plate assembly connected to the distal end of the control rod, the mounting plate assembly comprising a mounting plate and a tilt mechanism that alters a tilt angle of the mounting plate; and
a controller assembly disposed at the proximal end of the control rod that allows an operator to adjust the tilt angle and an azimuth of the mounting plate.

2. The control arm mounting bracket assembly as recited in claim 1, wherein the controller assembly further comprises:
a tilt controller that allows an operator to adjust the tilt of the mounting plate; and
an azimuth controller that allows an operator to adjust the azimuth of the mounting plate.

3. The control arm mounting bracket assembly as recited in claim 1, further comprising attachment means for attaching the proximal end of the support bar to a structure.

4. The control arm mounting bracket assembly as recited in claim 1, wherein the controller assembly is a manual controller.

5. The control arm mounting bracket assembly as recited in claim 1, wherein the controller assembly is an electronic controller.

6. The control arm mounting bracket assembly as recited in claim 5, wherein the electronic controller includes remote control means.

7. The control arm mounting bracket assembly as recited in claim 1, wherein the controller assembly is detachable from the mounting bracket assembly.

8. A wireless network antenna bracket, comprising:
a mounting plate on which a wireless network antenna can be mounted;
a controller configured to change an orientation of the mounting plate;
a control bar connected to the mounting plate and the controller that, when repositioned by the controller, changes the orientation of the mounting plate; and
wherein when the orientation of the mounting plate is changed, an orientation of the wireless network antenna is correspondingly change.

9. The wireless network antenna bracket as recited in claim 8, wherein:
the mounting plate is disposed on a first end of the control bar;
the controller is disposed on a second end of the control bar; and
the wireless network antenna bracket is connectable to a structural member of a building.

10. The wireless network antenna bracket as recited in claim 8, wherein the controller is a manual controller.

11. The wireless network antenna bracket as recited in claim 8, wherein the controller is an electronic controller.

12. The wireless network antenna bracket as recited in claim 11, wherein the controller is an electronic remote control controller.

13. The wireless network antenna bracket as recited in claim 8, wherein the controller is releasably attached to the control rod.

14. An antenna control bracket, comprising:
means for attaching an antenna to the bracket;
means for controlling an orientation of the antenna when the antenna is mounted on to the bracket; and
means for attaching the bracket to an overhead structure so that the antenna is disposed a distance from the structure.

15. The antenna control bracket as described in claim 14, wherein the means for controlling an orientation of the antenna further comprises means for controlling an azimuth orientation of the antenna.

16. The antenna control bracket as described in claim 14, wherein the means for controlling an orientation of the antenna further comprises means for controlling a tilt orientation of the antenna.

17. The antenna control bracket as described in claim 14, wherein the means for controlling an orientation of the antenna further comprises a control rod that moves in along a first axis to change a tilt of the antenna orientation and also along a second axis to change the azimuth of the antenna orientation.

18. The antenna control bracket as described in claim 14, wherein the means for controlling an orientation of the antenna further comprises a control rod that extends and retracts to change a tilt of the antenna orientation.

19. The antenna control bracket as described in claim 14, wherein the means for controlling an orientation of the antenna further comprises a control rod that rotates to change an azimuth of the antenna orientation.

20. The antenna control bracket as described in claim 14, wherein the means for controlling an orientation of the antenna are operated remotely from the antenna control bracket.
